(19) United States
(12) Patent Application Publication
(10) Pub. No.: US 2014/0108647 A1
(43) Pub. Date: Apr. 17, 2014

(54) User Feedback in Network and Server Monitoring Environments

(71) Applicant: BROCADE COMMUNICATIONS SYSTEMS, INC., San Jose, CA (US)

(72) Inventors: James Cole Bleess, Belmont, CA (US); Mark Allen Premo, San Clemente, CA (US); Tim Braly, North Pole, AK (US); Marcus Thordal, Los Gatos, CA (US)

(21) Appl. No.: 13/796,924

(22) Filed: Mar. 12, 2013

Related U.S. Application Data
(60) Provisional application No. 61/712,628, filed on Oct. 11, 2012.

(51) Int. Cl. H04L 12/26

(52) U.S. Cl. CPC H04L 43/08
USPC 709/224

(57) ABSTRACT

A system according to the preferred embodiments of the present invention utilizes performance monitoring tools on the network infrastructure and servers of a VDI environment to provide a performance indication to each user, based on his network path and his servers. The user may also provide feedback, such as a rating from one to five, of the performance of each of his applications. Ratings of other users may be provided to each user to provide additional performance indications. The ratings of the users may also be used by IT staff in conjunction with the network and server metrics to troubleshoot problem areas and to assist in planning future environments. The user feedback or rating can be used in other areas as well to allow improvement of the delivery of services.

### RELATED APPLICATIONS

This application is a non-provisional application of Ser. No. 61/712,628, titled “User Feedback in Network and Server Monitoring Environments,” filed Oct. 11, 2012, which is incorporated herein by reference.

### TECHNICAL FIELD

The invention relates to client, server and network performance monitoring.

### BACKGROUND

As an early cloud delivery model (Infrastructure as a Service, or IaaS), desktop virtualization, commonly referred to as virtual desktop infrastructure or virtual desktop interface (VDI), by its very nature transforms information technology (IT) infrastructure and processes—pulling complexity (Windows OS versioning and management, disk, memory, backup, data security) into the data center while pushing out mere screen data to thin/zero clients via Layer 4 protocols such as PCoIP (VMWare), RDP (Microsoft), and HDX (Citrix). Since all “desktop” interaction is now delivered over the end-to-end network, SLAs (Service Level Agreements) for latency reduce to 180 ms or less for suitable use. However, few if any tools are able to measure per-user latencies in scale, reliably, and across all applications. Worse, such tools are developed for and marketed to the already-burdened IT staff who have little or no time to use the tools for such granular yet inchoate user issues such as “Why is VDI slow today?” Further complicating matters is the help desk which, according to studies, simply passes on untriaged VDI calls to IT staff. Little wonder that industry evangelists warn that VDI will require not only more hardware but also more IT staff, putting VDI total cost of ownership justifications at risk. Thus, a solution to aid in delivering consistently high user satisfaction with the fewest IT staff possible is desirable.

### SUMMARY OF THE INVENTION

A system according to the preferred embodiments of the present invention utilizes performance monitoring tools on the network infrastructure and servers of a VDI environment to provide a performance indication to each user, based on the user's network path and servers. The user may also provide feedback, such as a rating from one to five, of the performance of each of his applications. Ratings of other users may be provided to each user to provide additional performance indications. The ratings of the users may also be used by IT staff in conjunction with network and server metrics to troubleshoot problem areas and to assist in planning future environments.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 is a block diagram of a physical and virtual VDI environment according to the present invention.

FIG. 2 is a messaging diagram according to the present invention.

FIG. 3 is a screen shot of an exemplary user display according to the present invention.

FIG. 4 is a screen shot of an exemplary administrator display of application server user experience metrics for a plurality of applications according to the present invention.

FIG. 5 is a screen shot of an exemplary administrator display of application server metrics for a single application according to the present invention.

### DETAILED DESCRIPTION OF THE PREFERRED EMBODIMENTS

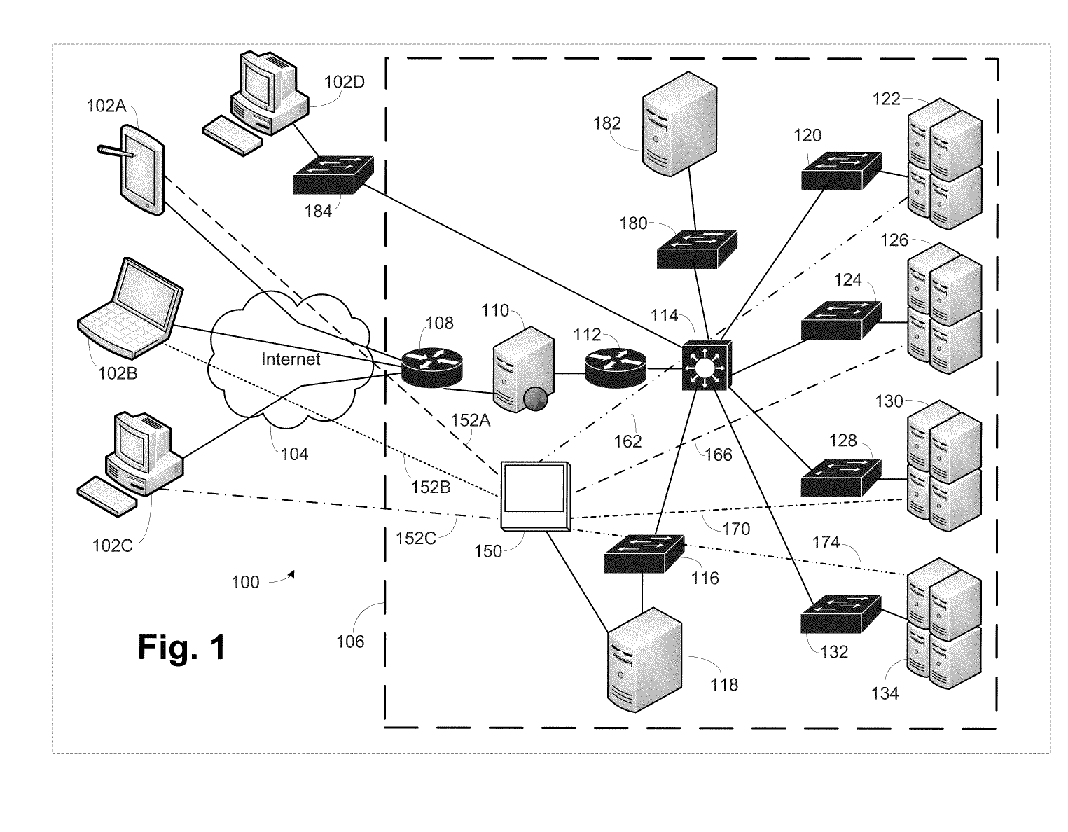

A VDI environment 100 according to an exemplary embodiment of the present invention is illustrated in FIG. 1. Individual users 102A, 102B and 102C, using, respectively, a tablet, a laptop and a desktop, are connected through the Internet 104 to the VDI data center 106. A router 108 is connected to the Internet 104 to communicates with the users 102A-102C. The router 108 is connected to a web server/firewall no (shown as one device for simplification), which is connected to another internal router 112. The internal router 112 is connected to a core switch 114, which is connected to a series of edge switches 116, 120, 124, 128 and 130. Each of the routers 108 and 112 and the switches 114, 116, 120, 124, 128 and 130 are configured for sFlow operation to provide network metrics to an sFlow collector. A VDI control server 118 is connected to the edge switch 116. Application servers 122, 126, 130 and 134 are connected to the edge switches 120, 124, 128 and 130, respectively. The application servers 122, 126, 130 and 134 execute various applications in the VDI environment, such as Microsoft Outlook®, Microsoft Lync®, Microsoft SharePoint®, Oracle® and Microsoft Remote Desktop. These are exemplary applications and other applications commonly used in VDI environments can be used. Each of the application servers 122, 126, 130 and 134 include sFlow agents to provide physical and virtual server metrics to an sFlow collector. Additionally, the applications themselves may include sFlow agents to provide further detailed application performance data.

The users 102A-102C connect through the web server 110 to the VDI control server 118 to establish their virtual desktops 150. In FIG. 1, the virtual desktop 150 is shown connected to the users 102A-102C by virtual links 152A-152C, though it is understood that the physical path is different, such as through the Internet 104, the router 108, the web server 110, the router 112, the core switch 114 and the edge switch 116. Likewise, the virtual desktop 150 is shown connected to the application servers 122, 126, 130 and 134 using virtual links 162, 166, 170 and 174, though the physical path is different. For example, user 102A would connect to application server 126 via the Internet 104, the router 108, the web server 110, the router 112, the core switch 114 and the edge switch 124.

A Traffic Sentinel® server 182 is connected through an edge switch 180 to the core switch 114. The Traffic Sentinel server 182 is described in more detail below.

An additional user 102D is illustrated connected to an edge switch 184, which is connected to the core switch 114. User 102D is thus an on premises user within the local area of the data center 106, such as a user in the corporate LAN environment. Thus, users in the VDI environment 100 can be connected to the data center 106 via the Internet or via a LAN connection.

This is an exemplary VDI environment and one skilled in the art would understand that there are numerous other VDI environment configurations and alternatives, depending both on the VDI vendor and the particular numbers of a given party.

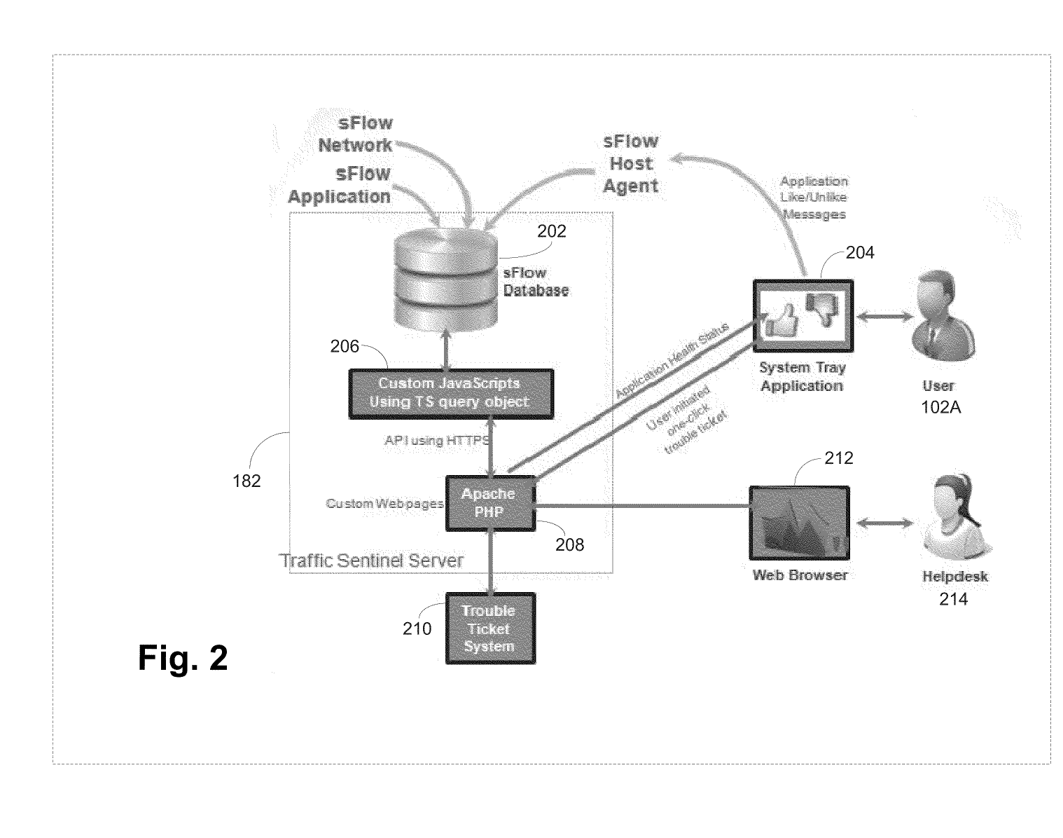

FIG. 2 illustrates the Traffic Sentinel server 182 which is an sFlow collector. Traffic Sentinel is a product from InMon Corp. that performs sFlow data collection and reporting, though it is understood that other sFlow collectors can be utilized. The sFlow database 202 in the Traffic Sentinel server 182 receives the sFlow messages from the network devices, such as the switches and routers, and from the applications and application servers. A third sFlow message source is an agent provided as part of a system tray application 204 present provided for the user, either on a user system 102 or as part of the virtual desktop 150. The user sFlow agent is used to provide like/unlike or ratings feedback on the various applications provided through the virtual desktop 150, the VDI environment of the user. This feedback can be provided via a data post via HTML protocol to a server that processes the communications and stores into a database, via an sFlow protocol and custom User Experience sFlow structure extension to the sFlow Application structure using either JSON input to an sFlow hsflowd daemon/agent on the users machine or directly to the sFlow collector, or by being embedded into existing client-server applications communications such as Remote Procedure Calls (RPC), etc.

An example of the HTML protocol is sending a URI of /userexperienceinput.php?client_id=<client id>&app_id=<app_id>&rating=<rating>&token=<security token>.

An example of the sFlow protocol and custom User Experience sFlow structure extension is {“flow_sample: {“app_name”: “oracle”, “app_operation”: {“operation”: “user.experience”, “attributes”: “rating=3”}}}.

An example of the embedding is void rate_user_experience (int rating).

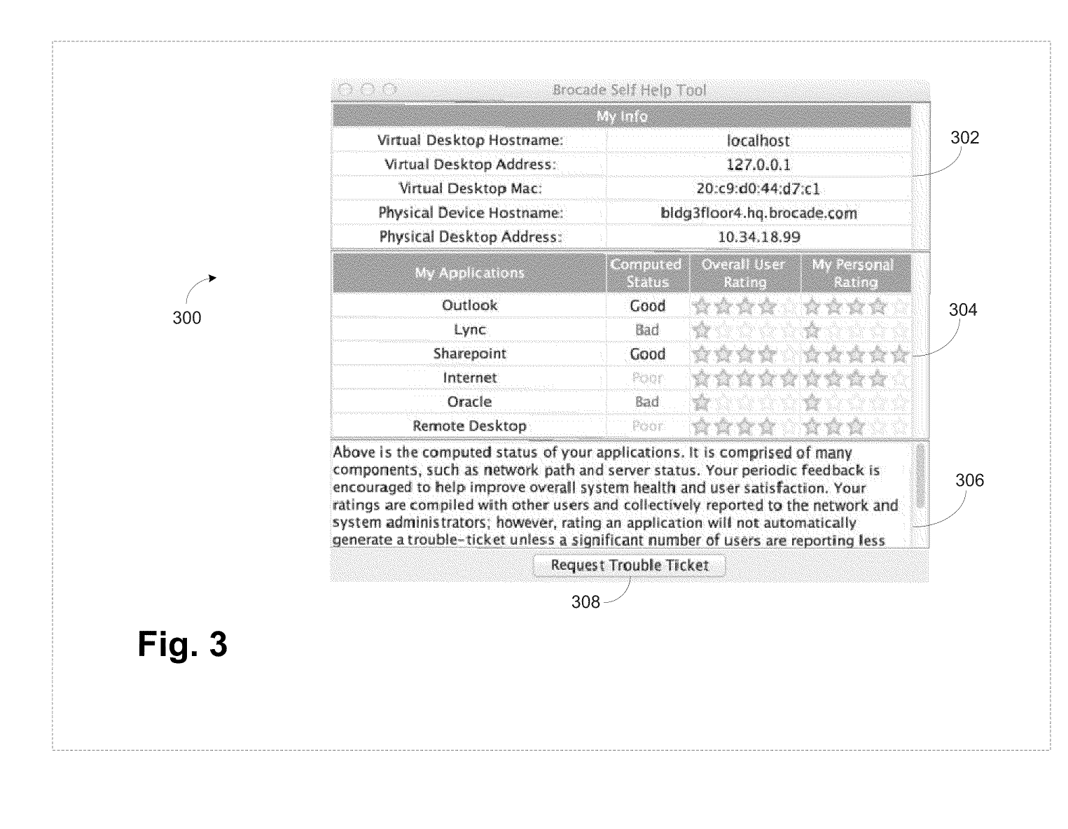

Traffic Sentinel provides an API and control of its query engine. To use the API and query engine a series of JavaScript programs 206, or other programs as desired, are provided to allow access to the data contained in the sFlow database 202. These JavaScript programs are contained on an Apache webserver 208 also executing on the Traffic Sentinel server 182. The system tray application 204 connects to the Apache webserver 208 to provide application status information as discussed above and as illustrated in FIG. 3. The system tray application 204 also contains a Request Trouble Ticket button 308 or similar to allow the user to send a trouble request to the IT department. The system tray application 204 provides this trouble request to the Apache webserver 208, which interfaces to a trouble ticket system 210. A web browser 212 executing on a computer of a Helpdesk or IT department user 214 accesses the Apache webserver 208 to receive status reports on the various applications, the network and the particular user.

FIG. 3 is a screen shot 300 of an exemplary system tray application 204. A first window portion 302 provides system information, such as virtual desktop hostname, address and MAC and the physical device hostname and address. A second window portion includes a listing of the various applications of the user, a computed status of the application, the cumulative overall user rating provided by all of the users and the individual user's personal rating of the applications. The computed status is based on the status of the application, the application server and all of the network links and switches or routers between the user and the application server. This is possible because the system knows the path from the user to the particular application server providing the application to the user and thus can obtain the sFlow metrics for the appropriate switches and routers. As the system also knows the particular application server, the system can obtain the sFlow metrics for the application and the application server. If the user is connected over the Internet, the user application may make use of various web performance monitoring tools, such as the Performance Resource Timing interface being developed by the W3C or similar JavaScript or timing software, to obtain the performance values related to the Internet portions of the communication. All of these metrics are then used in an equation or formula to provide the computed status. Various formulas or equations can be used, depending on the particular devices and applications and the IT department focus. The user can provide the user feedback by selecting a desired rating by clicking on the star appropriate to that rating for that application. When the star is clicked, the system tray application 204 provides this rating to the sFlow database 202 as discussed above.

A third window portion provides various explanatory text. A Request Trouble Ticket button 308 is provided to request a trouble ticket as described above.

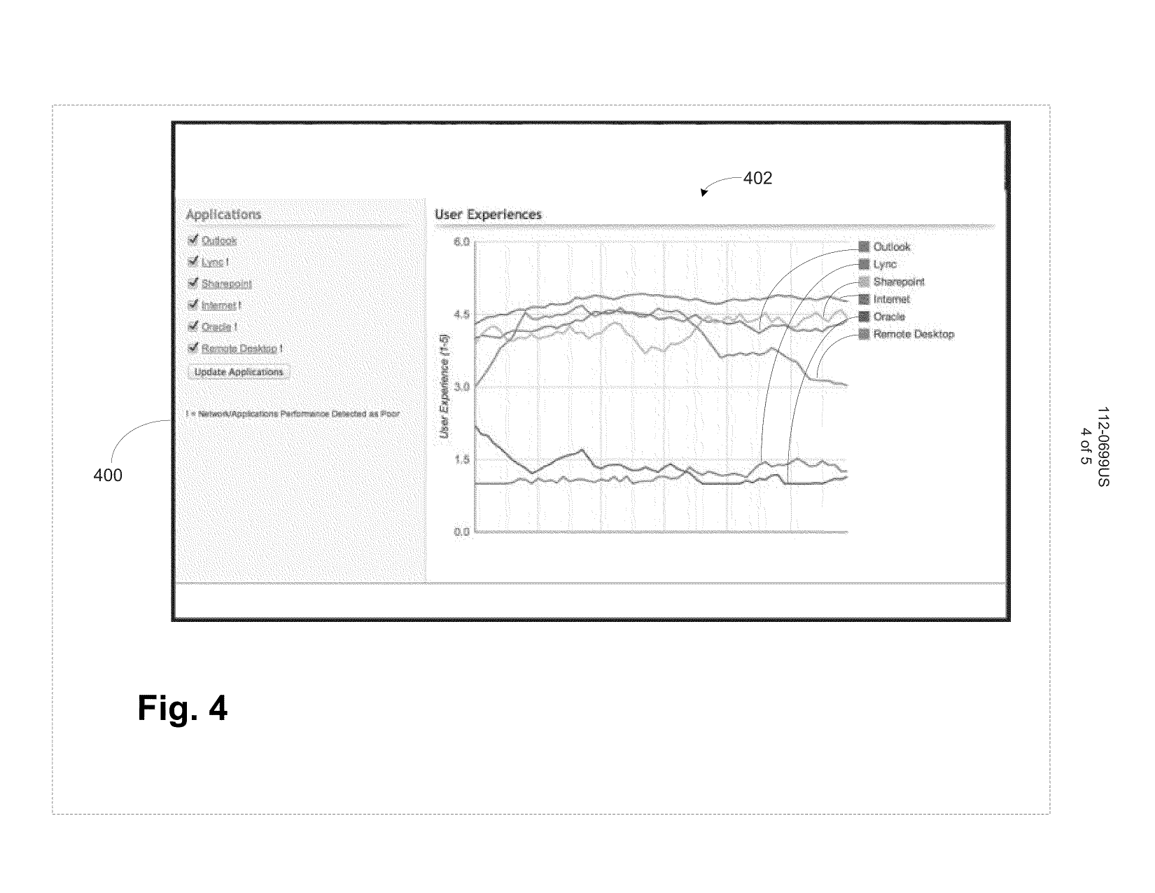

FIG. 4 is a first screen 400 used by the IT department to monitor user satisfaction of the various applications. This screen is provided by the Apache webserver 208 when the IT user requests this information. The IT user can select the desired applications to monitor. A graph 402 of the user experience ratings for the cumulative users is provided, the graph showing rating versus time. As can be seen, the low ratings of the Lync and Oracle applications match those provided on the screen shot 300, where both are rated bad. With this longer term low rating, the IT user can investigate potential problems with the Lync and Oracle applications to determine if there are any problems causing the low ratings. As the metrics are available for the application, the application server and at least portions of the network dedicated to the application server, this troubleshooting is simplified.

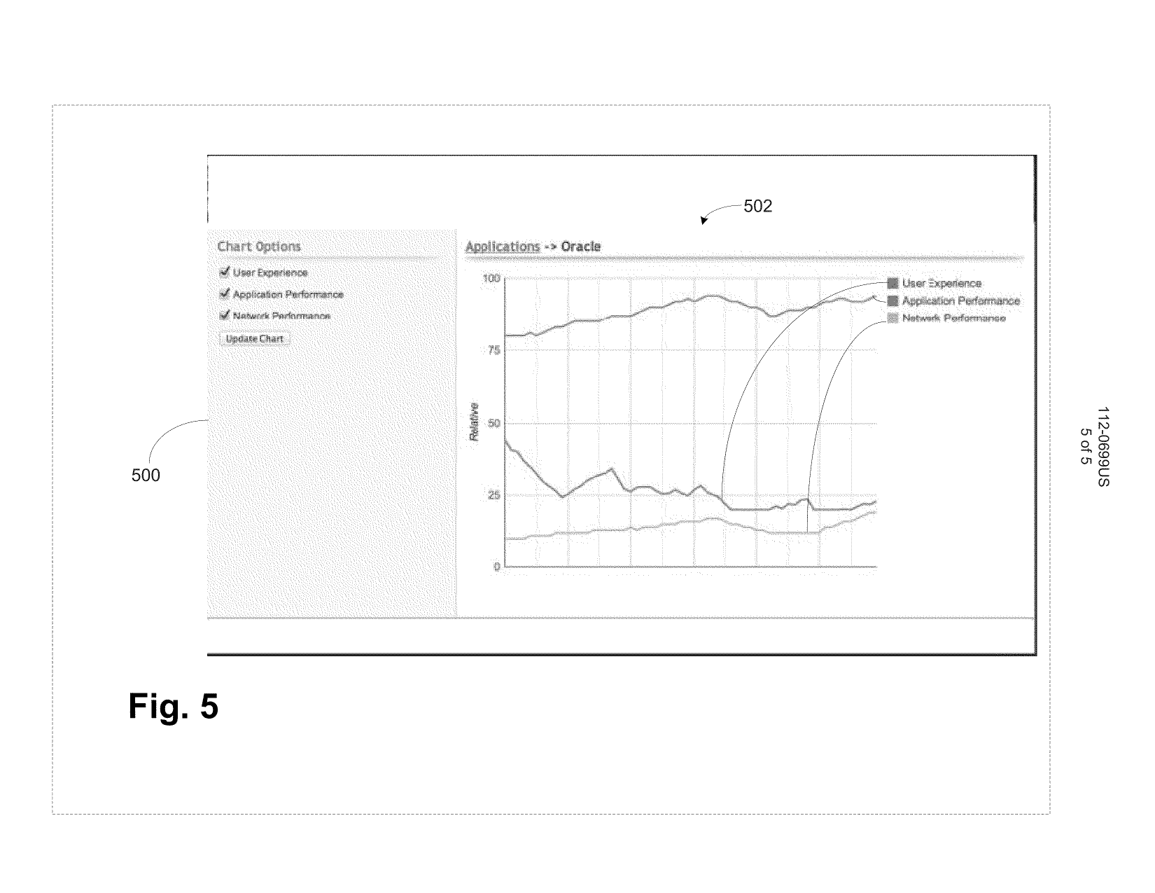

FIG. 5 is a second screen 500 used by IT department staff to monitor a particular application, in the illustrated instance, the Oracle application. A graph 502 shows the metrics for the Oracle application, specifically the application performance, network performance and user rating elements. In the illustrated graph, network performance is very low, which would appear to be the cause of the low user ratings.

The above system and elements gives each VDI user real-time information about the current (real-time) state and performance of his most-used applications (e.g., Microsoft desktop, SharePoint, Oracle, and the like) and provides summarized information about user satisfaction and its correlation to the performance of the underlying end-to-end infrastructure which alerts IT personnel to problem areas.

This provision of the user experience or user rating as feedback allows both current troubleshooting as discussed above and future capacity planning. For example, network metrics may suggest that a particular link is at or near capacity and expansion may be necessary. However, if all of the user ratings related to that link are high, indicating user satisfaction, then the expansion may be able to be delayed until the user experience begins to diminish, thus delaying the costs of the capacity expansion.

This user rating or experience feedback can be used in many other areas as well as the illustrated VDI example. For example, a built-in application on a cellular device (e.g., Edge, 3G, LTE) can allow users to rate their experience that is time-based and geo-referenced. Whenever a user rating is obtained, additional items, such as, signal strength, that are unique to that user's experience can be sent as well. As another example, Internet-based content delivery (e.g., Netflix, Hulu, Cable TV Providers and the like) on devices such as Roku, Apple TV, and cable TV set top boxes, use the user rating to get quality feedback from users via a button on their remote that allows quick three-click feedback. Click “Feedback”-“Press a number”-“Enter”. This is primarily based on simplicity. In other words, it should never be difficult for a user to initiate feedback.

A third example is to use the User Experience Feedback in the decision making process changes for Software Defined Networking (SDN), such as OpenFlow. For example, in the example above for content delivery feedback, providers can use that information to auto-provision additional bandwidth to keep users happy, but preferably only when the user feedback shows that they are unsatisfied.

Another example is the ISP's installing of an agent on their customer's machines that allow for user experience feedback of their Internet connections. In one embodiment, the feedback structure is set up in a way that allows all network clouds to monitor the user feedback. For example, when a user watching Internet TV on a Roku device decides to rate his/her experience, a packet is sent to the Roku server providing the content, but a copy of the packet is made by the Tier 2 ISP the user has service through before the packet traverses the Tier 1 ISP which also makes a copy of the packet before finally delivering it to the Content Delivery Provider. All Cloud/Service providers in the path now have the user experience information which they can analyze to help make decisions on their service delivery models.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system comprising:
a virtual desktop environment including a plurality of application servers and a plurality of applications;
a plurality of user computers for coupling to said virtual desktop environment, each user computer receiving a virtual desktop including a plurality of said plurality of applications;
a network including a plurality of switching devices, said network coupling said virtual desktop environment to said plurality of users; and
a performance monitoring server coupled to said applications, said application servers, said network and said plurality of user computers, said performance monitoring server receiving performance monitoring information from said applications, said application servers, said network and said plurality of user computers.

2. The system of claim 1, wherein said performance monitoring information provided by said plurality of user computers includes user feedback ratings of the applications available to one or more of the plurality of user computers in said virtual desktop.

3. The system of claim 1, wherein said performance monitoring server provides user application reports to each of said plurality of user computers and system reports to system administrators.

4. The system of claim 3, wherein said user application reports indicate the status of said plurality of applications in said virtual desktop.

5. The system of claim 3, wherein said system reports indicate status of said plurality of applications.

6. The system of claim 5, wherein, said status of an application is available as application status, network status and user feedback.

7. A system comprising:
a user device for coupling to a network and for receiving services over the network, said user device including a program for allowing a user to provide user feedback on services being provided over the network; and
a performance monitoring server for coupling to the network and for receiving user feedback from said user device, said performance monitoring server providing system reports to system administrators.

8. The system of claim 7, wherein said system reports indicate the status of the services being provided over the network.

9. The system of claim 8, wherein said status is available as individual components of the overall service.

10. The system of claim 7, wherein said user feedback includes user feedback ratings of the services being provided over the network.

11. The system of claim 7, wherein said performance monitoring server provides user services reports to a plurality of user devices on the network.

12. The system of claim 11, wherein said user services reports indicate the status of said plurality of services being provided over the network.

13. The system of claim 7, wherein said system reports indicate status of said plurality of services being provided over the network.

14. A system comprising:
a user device for coupling to a network and for receiving services over the network, said user device including a program for allowing a user to provide user feedback on services being provided over the network and for displaying status information on the services; and
a performance monitoring server for coupling to the network and for receiving user feedback from said user device and status information on the services and the individual components of the services.

15. The system of claim 14, wherein said performance monitoring server provides user reports to the user device.

16. The system of claim 15, wherein said user reports indicate the status of the services being provided over the network to the user device.

17. The system of claim 14, wherein said user feedback includes user feedback ratings of the services being provided over the network.

18. A method comprising:
providing a virtual desktop environment in a network, the virtual desktop environment including a plurality of application servers and a plurality of applications;
providing a plurality of user computers coupled to said virtual desktop environment through the network, each user computer receiving a virtual desktop including a plurality of said plurality of applications; and
receiving performance monitoring information from said applications, said application servers, said network and said plurality of user computers, wherein said performance monitoring information provided by said plurality of user computers includes user feedback ratings of the applications available to the user computer in the said virtual desktop.

19. The method of claim 18, further providing user application reports to each of said plurality of user computers.

20. The method of claim 19, wherein said user application reports indicate the status of said plurality of applications.

20. The method of claim 18, further providing system reports to system administrators.

21. The system of claim 20, wherein said system reports indicate status of said plurality of applications being provided.

22. The system of claim 21, wherein said status of said applications is available as application status, network status or user feedback.
